(19) United States
(12) Patent Application Publication
(10) Pub. No.: US 2007/0029425 A1
(43) Pub. Date: Feb. 8, 2007

(54) Fishing reel oscillation

(76) Inventor: John N. Young, Fairfax, CA (US)

Correspondence Address: PACIFIC PRODUCTS, 31 PAMARON WAY, STE. D, NOVATO, CA, 94949, US

(21) Appl. No.: 11/188,013

(22) Filed: Jul. 25, 2005

(51) Int. Cl. A01K 89/01

(52) U.S. Cl. 242/242

(57) ABSTRACT

In a fishing reel with a gear driven oscillation system, a non-sinusoidal gear oscillation function is achieved by changing the shape of the oscillation pin and its associated oscillation block groove to improve line lay as line is wound onto the spool of the reel.

### CROSS-REFERENCE TO RELATED APPLICATIONS

The following references are considered to be relative prior art.

U.S. Pat. No. 4,923,141

U.S. Pat. No. 5,143,318

U.S. Pat. No. 6,264,125 B1

U.S. Pat. No. 6,283,392 B1

U.S. Pat. No. 6,394,379 B1

U.S. Pat. No. 6,742,736 B2

U.S. Pat. No. 6,843,438 B1

### STATEMENT REGARDING FEDERALLY SPONSORED RESEARCH OR DEVELOPMENT

Not applicable

### REFERENCE TO SEQUENCE LISTING, TABLE, OR DISK APPENDIX

Not applicable

### BACKGROUND OF THE INVENTION

The category of fishing reels known as spinning reels have as a common feature a spool, a rotor with an attached driving means, a body to support said rotor and driving means and an oscillation system that serves to push the spool of the reel alternately into and then out of the reel body under a roller affixed to the reel rotor so as to distribute line over the full width of the spool arbor as the line is retrieved during fishing.

Oscillation systems are a well known and understood feature of spinning reels, and it is desirable that an oscillation system function to provide the most even lay of the line as it is rewound upon the spool.

Several well known oscillation-system schemes are used to provide various line-lay characteristics, and an oscillation system commonly known as an oscillation gear system is by far the most common mechanism utilized.

### PURPOSE OF THE INVENTION

It is a purpose of the invention to provide an improved spinning reel oscillation system of the oscillation-gear style to provide an improved line-lay on the spool as line is wound onto the spool of the reel during fishing.

It is a further purpose of the invention that this improved oscillation be simple enough to permit a simple retrofit to upgrade existing reels already using an oscillation-gear system.

A further purpose of the invention is to ensure that no new parts need be added to a reel to provide the improved oscillation, and that a minimum of the existing reel parts need be reconfigured to effect the improvement.

### BRIEF DESCRIPTION OF THE DRAWINGS

FIG. 1 is a partial side view of a spinning reel oscillation gear system showing the most common configuration.

FIG. 2 diagrams in alignment the movement of a theoretically perfect oscillation, the configuration and movement of the most common reel oscillation, and the resultant line-lay result of the existing oscillation-gear system.

FIG. 3 illustrates a known improvement to the standard oscillation gear system

FIG. 4 illustrates a number of possible oscillation pin shapes that may be realized using the embodiments of the invention.

FIG. 5 illustrates the resultant improved oscillation using one embodiment of the invention.

FIG. 6 illustrates the resultant improved oscillation using another embodiment of the invention.

FIG. 7 illustrates the resultant improved oscillation using another embodiment of the invention.

FIG. 8 illustrates the resultant improved oscillation using another embodiment of the invention.

FIG. 9 illustrates a known improvement to standard oscillation gear systems in which a variable-speed oscillation is achieved by using elliptical gear shapes.

FIG. 10 illustrates the resultant improvement to a variable speed oscillation system using an embodiment of the invention.

### DETAILED DESCRIPTION OF THE INVENTION

Well known within the category of fishing reels known as spinning reels is an oscillation-gear oscillation system that oscillates a spool back and forth under an axially fixed but rotating roller position during rewind of the fishing line to effect an even distribution of the line as it is wound upon the spool.

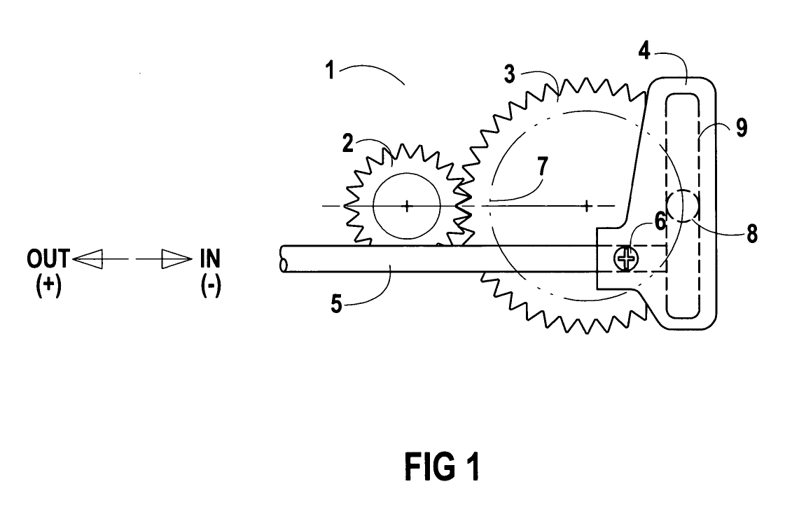

The most common configuration of the oscillation-gear system 1 is illustrated in FIG. 1 in which oscillation drive gear 2 is turned by a reel handle not shown. As is well known, said oscillation drive gear meshes with oscillation gear 3 to drive the oscillation gear into rotation as said reel handle is rotated.

Affixed to one face of said oscillation gear is pin 8 the center of which defines circular path 7 as the oscillation gear rotates. To establish a convention for the following discussion, the oscillation pin of FIG. 1 is shown at the 0° position of the oscillation gear, and we shall only consider the oscillation gear turning in a counterclockwise direction.

It is understood that the oscillation gear may be turned in either a clockwise or counterclockwise position without changing the following discussion and that the consideration of a counterclockwise rotation is only to facilitate a simplified discussion. Also assumed is a fixed single reel-handle turning speed for all descriptions.

As a further convention for the following discussion, the IN and OUT position of the main shaft 5 are indicated in FIG. 1.

Said main shaft is non-rotatably fixed to oscillation block 4 by screw 6, and said oscillation block is slideably affixed in said reel in a conventional manner. A spool to hold line, not shown, is carried by said main shaft to slide in unison with the main shaft in alternate IN and OUT directions.

Said oscillation block has groove 9 in which the oscillation pin slides as it is rotated with the oscillation gear so that the oscillation block and the affixed main shaft are alternately urged from a full OUT position to a full IN position and back again as the oscillation gear rotates.

A perfect oscillation system may be defined as one in which the spool is oscillated at a fixed speed in a first IN direction 101 and then at a fixed speed in the OUT direction 103 with no time required to effect the change from one direction to the other 102 and 104.

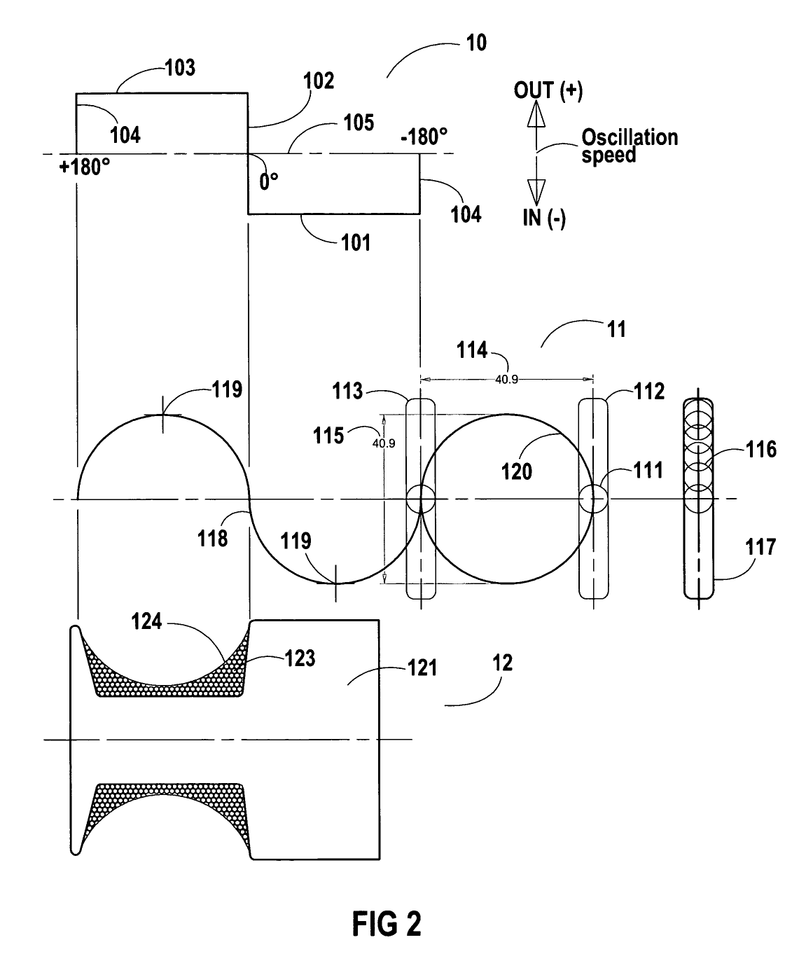

This idealized oscillation system function is diagramed as the rectangular wave diagram 10 of FIG. 2.

Referring to the idealized, rectangular oscillation, several points should be noted:
1. The displacement distance of the IN OUT direction 101, 103 from the centerline 105 indicates the relative speed of the oscillation stroke. The greater the distance from the centerline, the higher the speed.
2. The flatness of the curve portions 101 and 103 represents the constancy of the oscillation speed,
3. The distance from the 0° position toward either 180° position indicates length along the oscillation stroke and
4. The horizontal transition through the 0° or 180° positions indicates the time required to change from a first oscillation direction to the opposite oscillation direction. It may be noted that the rectangular shape of the idealized oscillation stroke makes the direction transit instantaneously.

In contrast to the idealized oscillation 10, the actual function of the most common oscillation system is illustrated by 11 in FIG. 2 which indicates only the most elemental components of the oscillation system. It should be noted that the function 11 is graphically aligned with the idealized function 10 in order to facilitate comparison between the two.

Oscillation pin 111 of common oscillation gear system 11 rotates along circular path 120 alternately from a 0° position to a 180° position and back to the 149 0° position as the oscillation gear is rotated. Saif oscillation pin is slideably retained in oscillation block groove 117 so that as said oscillation gear rotates said oscillation pin urges oscillation block groove alternately from a 0° position 112 to a 180° position 113 and back again to describe a fixed oscillation stroke length 114. The dimensions shown on the oscillation stroke are only a relative measure to permit comparison between various embodiments of the invention, and are not meant to indicate any particular oscillation length or other physical measurement.

The extension drawing 118 of the circular path of the oscillation pin illustrates the sinusoidal waveform of common oscillation gear systems and shows that the oscillation speed increases to a peak at the center of the stroke 119 in both IN OUT directions and reduces to zero at the 0° and 180° positions.

The resultant spool line-lay 12 of the sinusoidal oscillation shows that on spool 121 the line 123 forms a concave-shaped line lay 124. As is understood, said concave line-lay is formed because line is evenly applied radially about said spool at the same time that said spool is oscillating quickly through the center sections of the oscillation stroke and then slowing down, completely stopping, reversing direction and then speeding up again to transit in the opposite oscillation direction. These actions force line to build up quickly at the ends of the oscillation stroke and build slowly in the center sections of said stroke.

The concave line-lay of a common oscillation gear system is problematic in fishing, and various oscillation designs have been developed to try and produce other than a sinusoidal oscillation wave result while maintaining the simplicity and strength of the basic oscillation-gear drive mechanism.

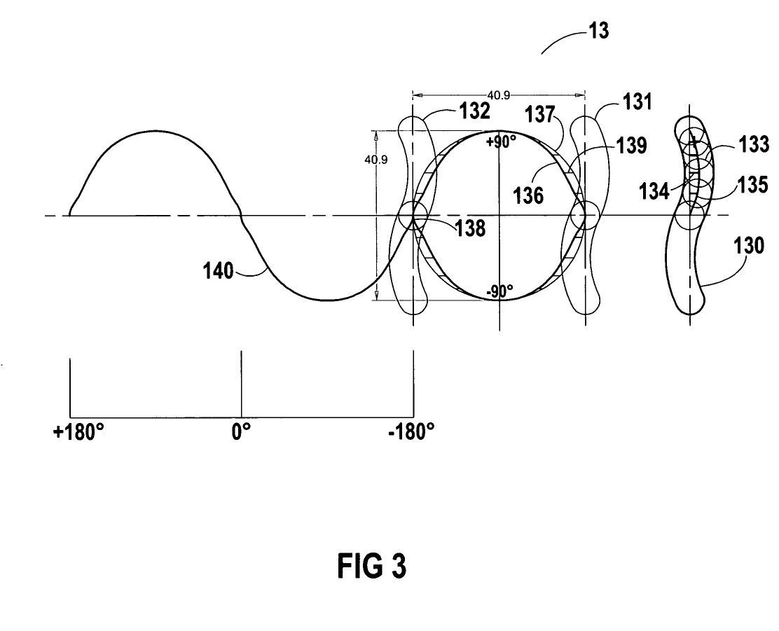

One known effort to produce other than a sinusoidal oscillation output involves changing the shape of the oscillation block groove to a substantially S-curved shape 130 as shown in FIG. 3.

In said S-curved oscillation system, the shape of the S-curve forces the oscillation pin into quicker engagement with the oscillation block groove at the 0°, 90°,180°, and 270° positions and into reduced engagement at the 45°,135°, 225° and 315° positions so that a distortion of the oscillation stroke speed occurs. The distortion at each angle of rotation 134 produces an overall oscillation distortion curve 135. The distortion at each angle may be transferred 139 to circular path 137 to illustrate the resultant oscillation speed curve 136 in which the transition through the 0° and 180° positions from one direction of oscillation to the other direction of oscillation is hastened to give a shortened slow and stop time at each extreme of the oscillation stroke and to consequently provide an improved line lay on the spool.

U.S. Pat. Nos. 5,143,318 and 6,264,125 teach alternate plans to utilize arched oscillation parts to improve upon the sinusoidal path of common oscillation gear systems.

U.S. Pat. No. 6,394,379 teaches a two-step oscillation pin and oscillation block groove that interact together to produce a non-sinusoidal oscillation output.

U.S. Pat. No. 6,742,736 teaches an elliptical gear oscillation gear drive that provides a variable speed oscillation gear drive to produce a non-sinusoidal oscillation output

The standard, circular oscillation pin found in common oscillation gear systems may be described as two axis', the end points of which are sequentially connected in sequence by a surface that is at all points equidistant from the center of the axis' crossing.

In all cases, the vertical center line of an oscillation pin defines the pressure center within an associated oscillation groove to determine the position of the oscillation block as it travels back and forth through its defined oscillation stroke.

The axis' that define the shape of an oscillation pin may be considered independent of each other, may be moved relative to each other and may be changed in dimension from each other to produce a variety of improved, non-sinusoidal oscillation strokes.

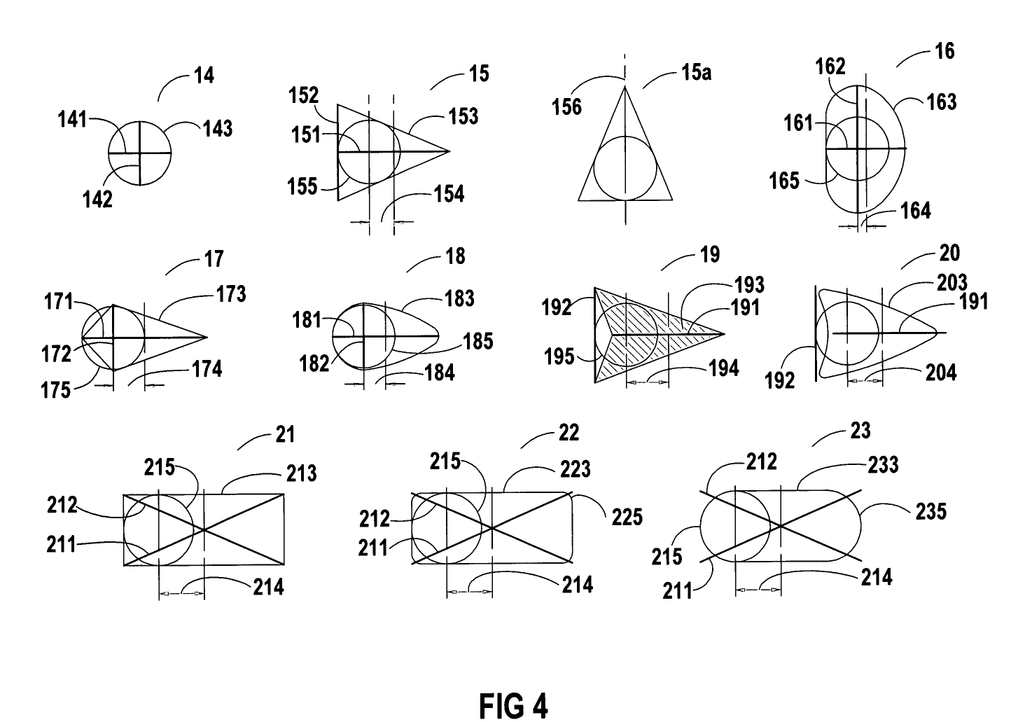

FIG. 4 illustrates a variety of oscillation pin shapes to demonstrate the effect on oscillation pin shape caused by various independent oscillation pin axis configurations.

Common, round oscillation pin 14 is defined by axis 141 and axis 142 that are of equal length and center-intersecting so that the surface of the pin 143 may describe a circle.

Oscillation pin 15 is illustrated in a horizontal alignment and is described by axis 152 and axis 151. Axis 152 is positioned at a distal endpoint of axis 151. The surface of oscillation pin 15 is formed by sequentially connecting the endpoints of the axis' to form a substantially triangular shape 153. Oscillation pin 15 is superimposed by the image of an equivalent circular oscillation pin 155 to show that the center point of said substantially triangular oscillation pin is offset 154 from the center point of an equivalent circular oscillation pin.

Oscillation pin 15a is the pin of 15 but is illustrated in a vertical alignment to demonstrate that the center axis of the pin moves into unitary alignment with the center of the equivalent circular pin as it rotates. It is understood that this movement of the pin center into and out of full alignment with the center of an equivalent circular pin as the pin rotates is a primary feature of all the non-circular pin descriptions that follow and will not be further illustrated.

Oscillation pin 16 shows a substantially bean-shaped oscillation pin in which axis 161 and 162 intersect each other and are not center aligned to give an off-center shape the center of which is offset 164 from the center of an equivalent circular oscillation pin. Further, the surface connecting the successive endpoints of the axis is well rounded to provide a smoother transition from one surface portion to the next.

Oscillation pin 17 is defined by intersecting axis 171 and axis 172 which are not center aligned. To form the outside shape, the endpoints of pin 17 axis' are sequentially connected to define a substantially arrowhead shape 173. The center point of pin 17 is offset 174 from the center of an equivalent circular pin 175.

Oscillation pin 18 is pin 17 but with the outside shape 183 rounded to give a smoother transition between portions of the surface. The center of pin 18 is offset 184 from the center of an equivalent round oscillation pin 185.

Oscillation pin 19 is defined by sequentially connecting the end points of non-intersecting axis' 191 and 192 to define a substantially arrow-shaped shape 193 that is shaded for easy recognition. The center of pin 19 is offset 194 from the center of an equivalent round oscillation pin 195.

Oscillation pin 20 is the same as pin 19 but with the outside shape rounded to give a smoother transition between portions of the surface. The center of pin 20 is offset 204 from the center of the equivalent round oscillation pin 192.

Oscillation pin 21 is defined by axis 211 and axis 212 which are not perpendicularly aligned. The surface shape 213 of pin 21 is defined by sequentially connecting the endpoints of the axis'. The center of pin 21 is offset 214 from the center of an equivalent round oscillation pin 215.

Oscillation pin 22 is pin 21 but with the corners 225 rounded for a smoother transition between the various portions of the pin surface. The center of pin 21 is offset 214 from the center of an equivalent round oscillation pin 215.

Oscillation pin 23 is pin 22 but further rounded 235 to give improved smooth transition between portions of the pin surface 233. The center of pin 23 is offset 214 from the center of an equivalent round oscillation pin 215.

It is understood that many more combinations of axis lengths, alignments and surface shapes may be generated, and that the above is but a representation group of shapes to facilitate the following descriptions.

To ultilize each new oscillation pin shape, the associated oscillation block groove must be shaped to permit the passage of the pin as it rotates along its said circular path. Those with knowledge of the art will know how to calculate each oscillation block groove shape to match the shape of its associated oscillation pin. Therefore the detailed description of the various following grooves shapes will be illustrated but not explained.

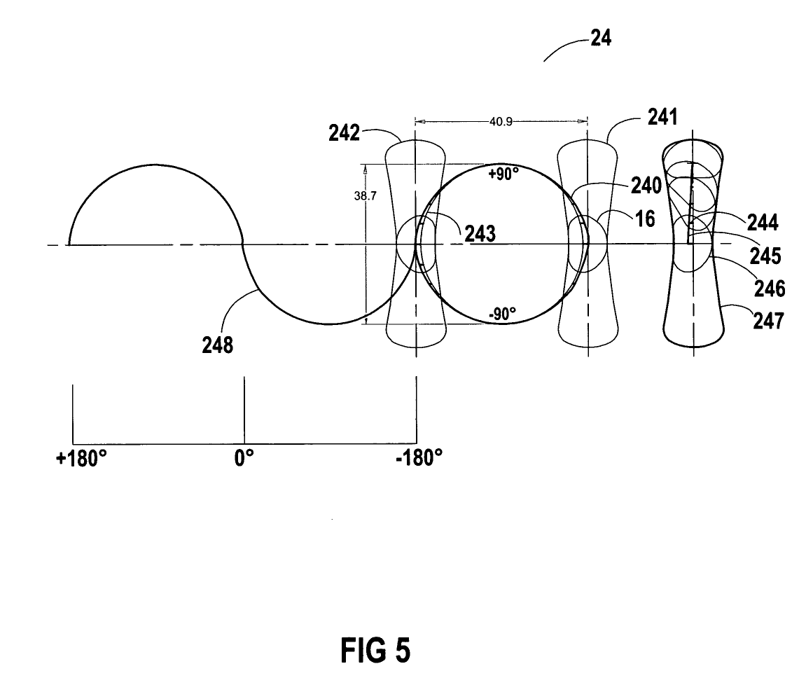

The oscillation system 24 of FIG. 5 utilizes oscillation pin 16 rotating inside oscillation groove 247 to drive the oscillation block alternately between the 0° position 241 and 180° position 242. Path 243 which said oscillation pin follows as it rotates with the oscillation gear is a circular path. Path 243 is the same circular path that would be followed by an equivalent circular oscillation pin.

As previously described, the center of the oscillation block is at all times aligned with the pressure center of the oscillation pin. Also as previously described, the center of the oscillation pin and the center of an equivalent circular oscillation pin alternately align and disalign as the oscillation pin rotates along said circular path.

In FIG. 24 it can be observed that at the 0° and 180° positions the center of the oscillation block achieves maximum offset from the center of an equivalent circular pin while at the 90° positions the center of the oscillation pin moves into alignment with the center of an equivalent round oscillation pin. This alternating alignment and separation 244 of the non-circular pin center and equivalent circular pin center as the oscillation pin rotates 246 within the oscillation block groove distorts the motion of the oscillation block and causes a distortion curve 245. This distortion curve may be plotted on top of the circular path 243 to give the resultant oscillation block speed curve 240.

Since the non-circular oscillation pin stretches the oscillation stroke at the 0° and 180° positions, the path of its equivalent round oscillation pin may be reduced in diameter to retain an unchanged total oscillation stroke. This reduction in the pin path diameter produces a lower peak speed at the 90° positions to further flatten the resultant speed curve.

As described above, an ideal oscillation curve has the flattest possible curve during the transit from the full IN position to the full OUT position and back again and the shortest possible transit time from one direction of oscillation to the other. Speed curve 243 diagrams a speed curve that shows a flattened or reduced maximum speed at the 90° positions and stretched oval end points that force the oscillation block to pass through the 0° and 180° direction-reversal positions more quickly than in the sinusoidal curve of a common round-oscillation pin system.

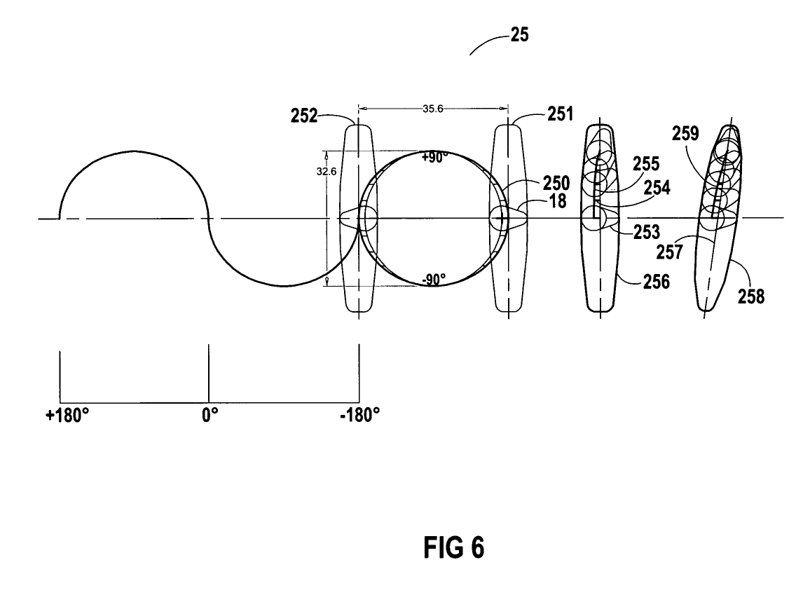

FIG. 6 illustrates the same principle but utilizes the oscillation pin of diagram 18. The rotation of oscillation pin 18 forces the shape of oscillation block groove 256. As the oscillation pin rotates 253 within the oscillation block groove, the offset 254 between oscillation pin center and an equivalent circular oscillation pin center describes a distortion curve 255. The distortion curve may be plotted on top of the equivalent circular pin path to produce the resultant oscillation block speed curve 250. Speed curve 250 illustrates a stretched oval that has a flattened maximum speed at the 90° positions and a curve at the 0° and 180° positions that forces the oscillation block to change direction more quickly than the sinusoidal curve of an equivalent circular oscillation pin.

Though not sketched herein with multiple pin shape options, it is understood that there may be more than one option available for the shape of the oscillation block groove for any given oscillation pin shape. An example of one optional oscillation block groove shape is illustrated by tilting the axis 257 of the oscillation block groove of 25 to force an altered oscillation block groove shape 258. In this example, it can be seen that tilting the oscillation block groove also slightly changes the shape of the distortion curve 259. Tilting the oscillation block groove axis or other changes to the oscillation block groove may be used to vary the speed curve shape or to adjust the mechanism dimensions to fit differently within a reel body.

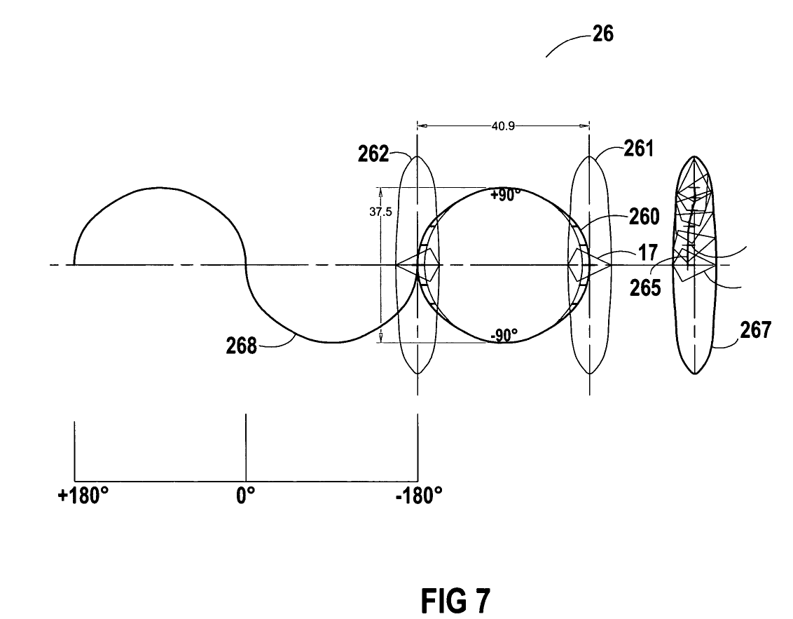

FIG. 7 illustrates an gear oscillation system utilizing the oscillation pin of diagram 17. In the manner already described, the resultant speed curve 260 diagrams a stretched oval that has a flattened maximum speed at the 90° positions and a curve at the 0° and 180° positions that forces the oscillation block to change direction more quickly than an equivalent circular oscillation pin.

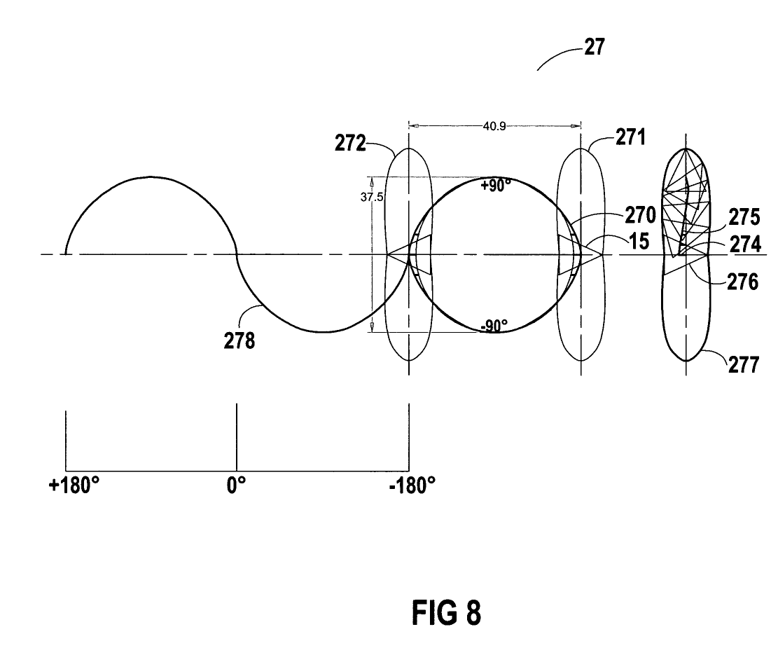

FIG. 8 illustrates the same principle but utilizing the oscillation pin of diagram 15. In the manner already described, the resultant speed curve 270 diagrams a stretched oval that has a flattened maximum speed at the 90° positions and a curve at the 0° and 180° positions that forces the oscillation block to change direction more quickly than the sinusoidal curve of an equivalent circular oscillation pin.

It may be noted that various adjustments to the speed curve may be achieved by a wide variety of oscillation pin shapes that adhere to the described principles, and all possible pin shape options are not sketched and repeatedly explained.

In known variable speed oscillation system in which oval gears produce a varying oscillation gear rotation speed the speed curve is improved over conventional oscillation gear systems using round oscillation gears. Known variable speed oscillation systems use round oscillation pins and these oval gear systems can be further improved by using the non-circular pins of the invention.

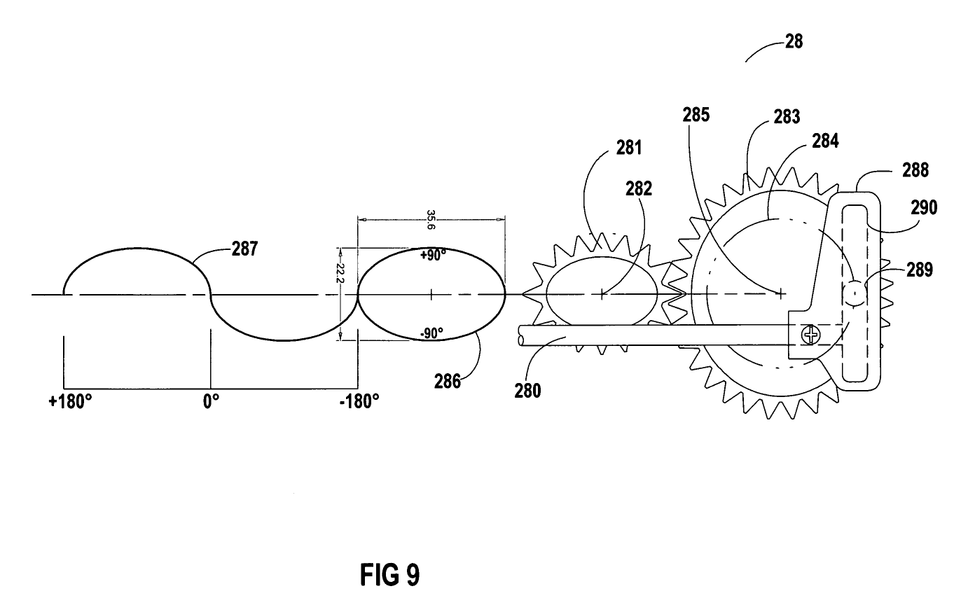

The detailed advantages of an oval gear oscillation system are taught in U.S. Pat. No. 6,742,736 and will not be further clarified. FIG. 9 shows the general construction 28 of an oval-geared oscillation system which produces a changing rotational speed of oval oscillation gear 283 as it is geared to be turned by oval oscillation drive gear 281 which is rotated around axis 282 in a conventional manner by a reel handle not shown. Though the oscillation gears are oval in shape, the path followed by round oscillation pin 289 is a circle 284 and only the speed of passage around this circular path is changed by the action of the oval gears. As is conventional, the oscillation pin rotates within oscillation block groove 290 of oscillation block 288 to urge main shaft 280 into motion in alternating OUT and IN directions.

The extension drawing 287 of resultant speed curve 286 of the variable speed gears may be observed as improved over the sinusoidal curve produced by the common round gear oscillation system of FIG. 1 and FIG. 2.

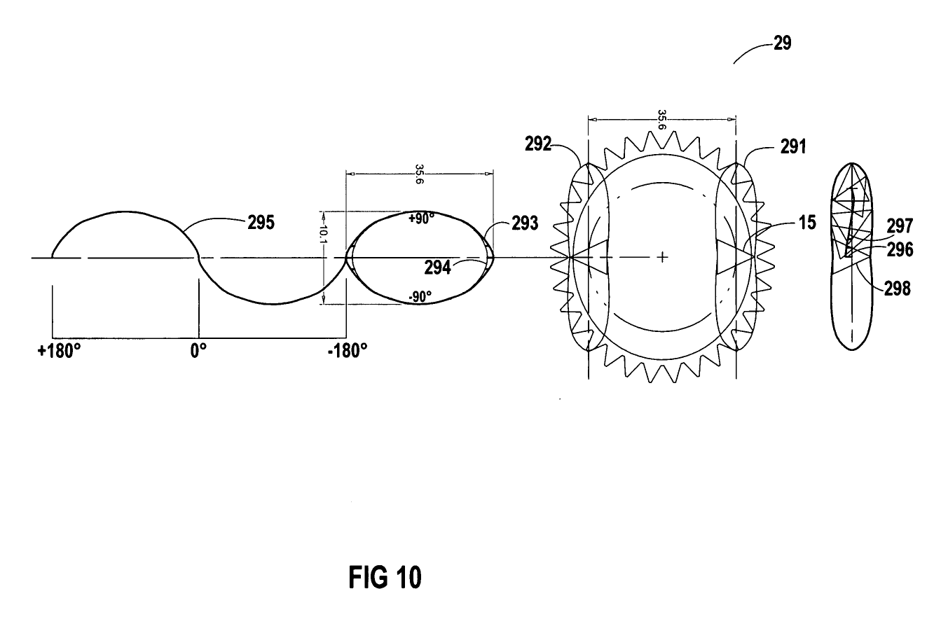

The oscillation system of FIG. 10 illustrates the effect of replacing the round oscillation pin of FIG. 9 with one of the above described pin shapes 15. With the same functions and for the same reasons as above described on circular gear systems, the non circular oscillation pin 15 applied to the oval gear system produces similar results and improvements as above described for round gears. Oscillation pin 298 rotates within the oscillation groove as the oscillation gear rotates and produces distortion curve 297 which distorts speed curve 294 to become speed curve 293. In the same manner as on round gear systems, the center offset of pin 15 stretches the speed curve to give a flatter shape at the 90° positions and a speedier transit of the oscillation block through the 0° and 180° direction-changing positions.

Understood is that using any of the non-circular oscillation pins embodiments on an oval-gear variable speed oscillation system produces equivalent results and benefits as when applied on conventional round-gear oscillation systems. Therefore further oscillation pin shapes applied on oval gear oscillation systems will not be illustrated or repeatedly described.

1. The oscillation system of a fishing reel comprising:
a driven substantially round oscillation gear rotationally fixed to the reel, one side surface of which includes an appended single-step oscillation pin of non circular shape that rotates along a circular path as the oscillation gear is driven,
an oscillation block slideably mounted in said fishing reel and shaped to include a groove to accept said non-circular oscillation pin such that as the oscillation pin rotates along said circular path the oscillation block is urged alternately from one sliding direction into an opposite sliding direction and back again,
a main shaft slideably supported in said fishing reel and affixed to said oscillation block so as to oscillate in unison therewith,
a spool carried on said main shaft to oscillate therewith as line is wound around the spool by conventional means.

2. The oscillation system of a fishing reel comprising:
a driven substantially round oscillation gear rotationally fixed to the reel, one side surface of which includes an appended single-step oscillation pin of non circular shape that rotates along a circular path as the oscillation gear is driven, said non circular oscillation pin shape being defined by the sequential connection of the endpoints of at least two axis'.
an oscillation block slideably mounted in said fishing reel and shaped to include a groove to accept said non-circular oscillation pin such that as the oscillation pin rotates along said circular path the oscillation block is urged alternately from one sliding direction into an opposite sliding direction and back again,
a main shaft slideably supported in said fishing reel and affixed to said oscillation block so as to oscillate in unison therewith,
a spool carried on said main shaft to oscillate therewith as line is wound around the spool by conventional means.

3. The oscillation system of claim 1 in which said single-step non-circular oscillation pin shape comprises a substantially triangular or oval or cam or bean or arrowhead or rectangular shape.

4. The oscillation system of claim 3 in which the said oscillation pin shapes have rounded edges to form smooth transitional surfaces.

5. The oscillation system of claim 2 in which said single-step oscillation pin shape comprises a substantially triangular or oval or cam or bean or arrowhead or rectangular shape.

6. The oscillation system of claim 5 in which the said oscillation pin shapes have rounded edges to form smooth transitional surface.

7. The oscillation system of claim 1 in which said oscillation block groove shape is defined by the locus of points established by the outermost edges of the non-circular oscillation pin as it rotates along said circular path.

8. The oscillation system of claim 2 in which said oscillation block groove shape is defined by the locus of points established by the outermost edges of the non-circular oscillation pin as it rotates along said circular path.

9. The oscillation system of a fishing reel comprising:
a driven substantially oval oscillation gear rotationally fixed to the reel, one side surface of which includes an appended single-step oscillation pin of non circular shape that rotates along a circular path as the oval oscillation gear is driven,
an oscillation block slideably mounted in the fishing reel and shaped to include a groove to accept said non-circular oscillation pin such that as said non-circular oscillation pin rotates along said circular path the oscillation block is urged alternately from one sliding direction into an opposite sliding direction and back again,
a main shaft slideably supported in said fishing reel and affixed to said oscillation block so as to oscillate in unison therewith,
a spool carried on said main shaft to oscillate therewith as line is wound around the spool by conventional means.

10. The oscillation system of a fishing reel comprising:
a driven substantially oval oscillation gear rotationally fixed to the reel, one side surface of which includes an appended single-step oscillation pin of non circular shape that rotates along a circular path as the oscillation gear is driven, said non circular oscillation pin shape being defined by the sequential connection of the endpoints of at least two axis'.
an oscillation block slideably mounted in the fishing reel and shaped to include a groove to accept said non-circular oscillation pin such that as the oscillation rotates along said circular path the oscillation block is urged alternately from one sliding direction into an opposite sliding direction and back again,
a main shaft slideably supported in said fishing reel and affixed to said oscillation block so as to oscillate in unison therewith,
a spool carried on said main shaft to oscillate therewith as line is wound around the spool by conventional means.

11. The oscillation system of claim 9 in which said single-step non-circular oscillation pin shape comprises a substantially triangular or oval or cam or bean or arrowhead or rectangular shape.

12. The oscillation system of claim 11 in which the said oscillation pin shapes have rounded edges to form smooth transitional surfaces.

13. The oscillation system of claim 10 in which said single-step non-circular oscillation pin shape comprises a substantially triangular or oval or cam or bean or arrowhead or rectangular shape.

14. The oscillation system of claim 13 in which the said oscillation pin shapes have rounded edges to form smooth transitional surfaces.

15. The oscillation system of claim 9 in which said oscillation block groove shape is defined by the locus of points established by the outermost edges of the non-circular oscillation pin as it rotates around said circular path.

16. The oscillation system of claim 10 in which said oscillation block groove shape is defined by the locus of points established by the outermost edges of the non-circular oscillation pin as it rotates around said circular path.

17. The oscillation system of claim 1 in which the oscillation block axis is tilted at other than a vertical angle.

18. The oscillation system of claim 2 in which the oscillation block axis is tilted at other than a vertical angle.

19. The oscillation system of claim 9 in which the oscillation block axis is tilted at other than a vertical angle.

20. The oscillation system of claim 10 in which the oscillation block axis is tilted at other than a vertical angle.
